(19) United States
(12) Patent Application Publication
(10) Pub. No.: US 2002/0122417 A1
(43) Pub. Date: Sep. 5, 2002

(54) Selection of voice connection type

(76) Inventors: Kory Wade Miller, Snohomish, WA (US); Melody Lee Moore, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/090,134

(22) Filed: Feb. 28, 2002

Related U.S. Application Data
(60) Provisional application No. 60/272,889, filed on Mar. 2, 2001.

(51) Int. Cl. H04L 12/66

(52) U.S. Cl. 370/352; 370/356

(57) ABSTRACT

A system and computer-based method for allowing a user to control the switching between a PSTN voice communication link between a user computer and a remote telephone and a VoIP voice communication link is disclosed. A soft-phone application running on a user computer allows a user to suspend a phone call at the switch port of a server computer connected to an exchange and switch from a PSTN connection to a VoIP connection or vice versa.

### CROSS-REFERENCE(S) TO RELATED APPLICATION(S)

This application claims the benefit of prior U.S. Provisional Patent Application No. 60/272,889, filed on Mar. 2, 2001, priority from the filing date of which is hereby claimed under 35 U.S.C. § 119.

### FIELD OF THE INVENTION

The present invention is related to the field of software communication systems and, in particular, software communication systems wherein a voice communication link can be switched between a Public Switched Telephone Network connection and a Voice Over IP connection.

### BACKGROUND OF THE INVENTION

In recent years, there has been a tremendous proliferation of computer-related telephone communication systems that have begun to infiltrate the Public Switched Telephone Network (PSTN). Voice Over IP (VoIP) is one way in which a voice communication link can be realized using a computer-related telephone communication system. In a VoIP connection, a user computer has a single data connection to a server computer which in turn has a connection to an exchange, such as a corporate private branch exchange (PBX) capable of connection to many other telephones either via the PBX or via the PBX and the PSTN. On the single data connection, call control data, as well as voice data, are sent and received by a software application running on the user computer over a TCP/IP connection to the server computer. A VoIP communication link is an effective way of using existing intranets and the Internet to establish a voice communication link between remote telephones and a user computer. However, during high traffic or interruptions on a network, real-time communication becomes problematic. A standard PSTN connection does not suffer from a real-time communication slowdown because it uses isolated communication network links that are not affected by high traffic or other computer network related problems.

In the past, software applications were able to detect problems on a particular network and determine if a real-time communication interruption was about to occur. At this point, the software application was able to switch the voice communication link from a Voice Over IP (VoIP) connection to a Public Switched Telephone Network (PSTN) connection. However, once this switch was made, software applications were unable to switch the voice communication link back to a VoIP connection. Furthermore, the user had no control over the switching process as a software determination initiated the switch from a VoIP connection to a PSTN connection. The present invention overcomes these limitations of previous software applications and voice communication systems by allowing a user of a voice communication link to freely switch between a VoIP connection and a PSTN connection.

### SUMMARY OF THE INVENTION

The present invention is directed to a system and computer-based method for allowing a user to control the back and forth switching of voice communication between a PSTN communication connection between a user computer and a remote telephone and a VoIP communication connection. The present invention can be used to extend the functionality of a telephone communication exchange, such as a corporate PBX, to remote users, giving the remote user access to all of the features and functions of a typical telephone communication exchange. This is accomplished by using a “soft-phone” graphical user interface (GUI) application running on a user computer. Commands from the soft-phone control a server computer that provides switching functionality between the user computer and remote telephones connected to the server computer through a telephone exchange. During a voice communication session between a user computer and a remote telephone, the user has the ability to initiate a change in connection type between a PSTN connection and a VoIP connection.

In accordance with other aspects of the invention, a remote telephone and a user at a user computer location can communicate in one of two ways: via a PSTN connection or via a VoIP connection. A PSTN connection can be established between the remote telephone and a regular telephone at the user's location. A VoIP connection can be between a remote telephone and a soft-phone on the user's computer at the user's location.

In accordance with further aspects of the present invention, a user establishes a VoIP connection through a single data connection from the user computer to a server computer. Call control data and voice data are promulgated between the user computer and the server computer through the single data connection. The server computer provides a switching system between the user computer and the exchange. On the single data connection, call control data is sent and received by a VoIP client application running on the user computer. The VoIP client application communicates with the server computer over a suitable (e.g. TCP/IP) connection to the network. To transmit and receive voice data, a user typically uses an integrated headset and boom microphone plugged into the user's computer soundcard. Voice data to and from the headset/microphone passes through the soundcard, and from there, it is encoded and “packetized” for sending, or “depacketized” and decoded for receiving by the user's computer. Call control data and voice data are processed by different program modules running on the server computer.

In accordance with still further aspects of the present invention, a user can suspend a phone call at a switch port of the server computer and toggle from a PSTN connection to a VoIP connection or vice versa. In one embodiment, a user who has established a VoIP connection to a remote telephone can initiate a switch to a PSTN connection. The call is interrupted at the switch port and a PSTN port object is created at the server computer. Upon establishing a voice communication link between the newly created PSTN port and the user computer, the server computer deconstructs the previous VoIP port used in the initial voice communication link. At that point, the call suspended at the switch port is re-directed to the newly created PSTN port and the voice communication link is re-established. Similarly, in another embodiment, a user who has established a PSTN connection to a remote telephone can initiate a switch to a VoIP voice communication link. The call is interrupted at the switch port and a VoIP port object is created at the server computer. Upon establishing a connection between the newly created VoIP port and the user computer, the server computer deconstructs the previous PSTN port used in the initial voice communication link. At that point the call suspended at the switch port is re-directed to the newly created VoIP port and the voice communication link is re-established.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a general purpose computer system suitable for implementing the present invention.

FIG. 2 is a pictorial representation of a communication system implementing the present invention.

FIG. 2A is a pictorial representation illustrating in more detail the VoIP channel of the communication system shown in FIG. 2.

FIG. 3 is a flow diagram illustrating the process of detecting whether a computer system is configured for both VoIP and PSTN connections.

FIG. 4 is a flow diagram illustrating the process of implementing a change between VoIP and PSTN connections.

FIG. 5 is a pictorial representation of the steps involved in disconnecting a VoIP connection.

FIG. 6 is a flow diagram illustrating the process of disconnecting a VoIP or PSTN connection.

FIG. 7 is a flow diagram illustrating the process of creating a new voice communication link for both VoIP and PSTN.

FIG. 8 is a pictorial representation of the steps involved in re-establishing a PSTN connection.

FIG. 9 is a flow diagram illustrating the process of re-connecting a PSTN connection.

FIG. 10 is a pictorial representation of the steps involved with disconnecting a PSTN connection.

FIG. 11 is a flow diagram illustrating the process of disconnecting PSTN connection.

FIG. 12 is a pictorial representation of the steps involved with re-establishing a VoIP connection.

FIG. 13 is a flow diagram illustrating the process of re-connecting VoIP connection.

### DETAILED DESCRIPTION OF THE PREFERRED EMBODIMENT

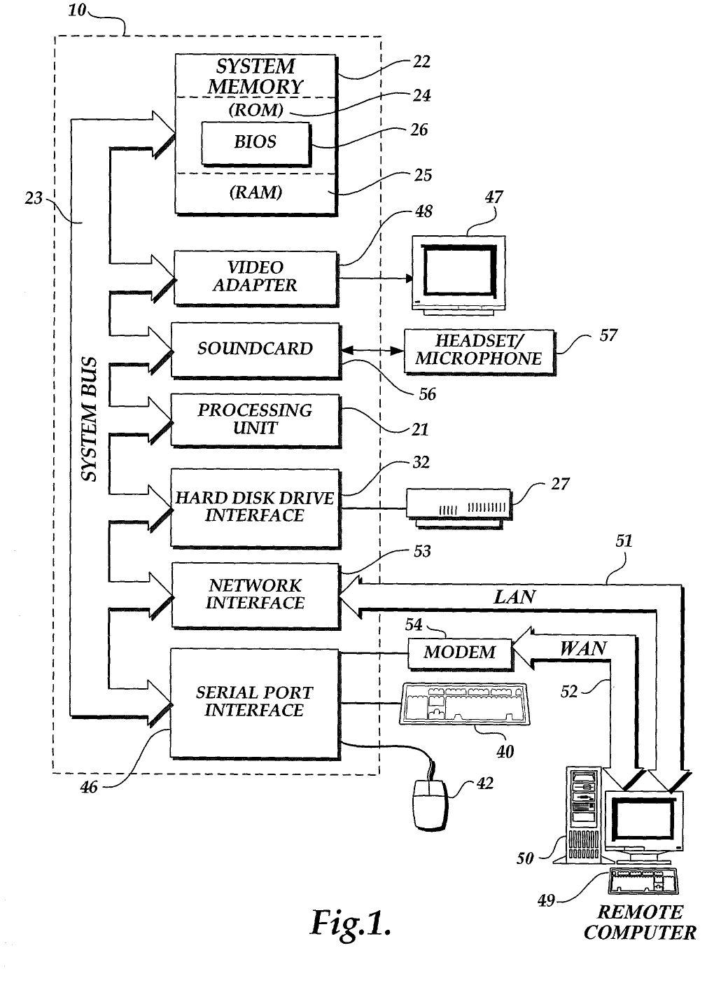

FIG. 1 and the following discussion are intended to provide a brief, general description of a suitable computing environment in which the invention may be implemented. Although not required, the invention will be described in the general context of computer-executable instructions, such as program modules, being executed by a personal computer. Generally, program modules include routines, programs, objects, components, data structures, etc., that perform particular tasks or implement particular abstract data types. Moreover, those skilled in the art will appreciate that the invention may be practiced with other computer system configurations.

The exemplary computer system shown in FIG. 1 includes a general purpose computing device in the form of a conventional personal computer 10, including a processing unit 21, a system memory 22, and a system bus 23 that couples various system components including the system memory to the processing unit 21. The system memory includes read only memory (ROM) 24 and random access memory (RAM) 25. A basic input/output system (BIOS) 26, containing the basic routines that help to transfer information between elements within the personal computer 10, such as during start-up, is stored in ROM 24. The system bus 23 may be any of several types of bus structures including a memory bus or memory controller, a peripheral bus, and a local bus using any of a variety of bus architectures. The personal computer 10 further includes a hard disk drive 27 for reading from and writing to a hard disk, not shown. The hard disk drive 27, is connected to the system bus 23 by a hard disk drive interface 32.

A number of program modules may be stored on the hard disk, including an operating system, one or more application programs, other program modules, and program data. A user may enter commands and information into the personal computer 10 through input devices such as a keyboard 40 and pointing device 42. Other input devices, such as a microphone (not shown) can also be used. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. A headset and microphone 57 are also connected to the system bus 23 via an interface, such as a sound card 56. In addition to the monitor, headset and microphone, personal computers typically include other peripheral output devices (not shown), such as printers, speakers, scanners, etc.

The personal computer 10 may operate in a networked environment using logical connections to one or more remote computers, such as remote computer 49. The remote computer 49 may be another personal computer, a server, a router, a network PC, a peer device or other common network node, and typically includes many or all of the elements described above relative to the personal computer 10, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet. As depicted in FIG. 1, the remote computer 49 can communicate with the personal computer 20 via the local area network 51 or via the wide area network 52.

When used in a LAN networking environment, the personal computer 10 is connected to the local network 51 through a network interface or adapter 53. When used in a WAN networking environment, the personal computer 10 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 10, or portions thereof, may be stored in the remote memory storage device. It will be appreciated that the network connections shown are exemplary and other means of establishing a communications link between the computers may be used.

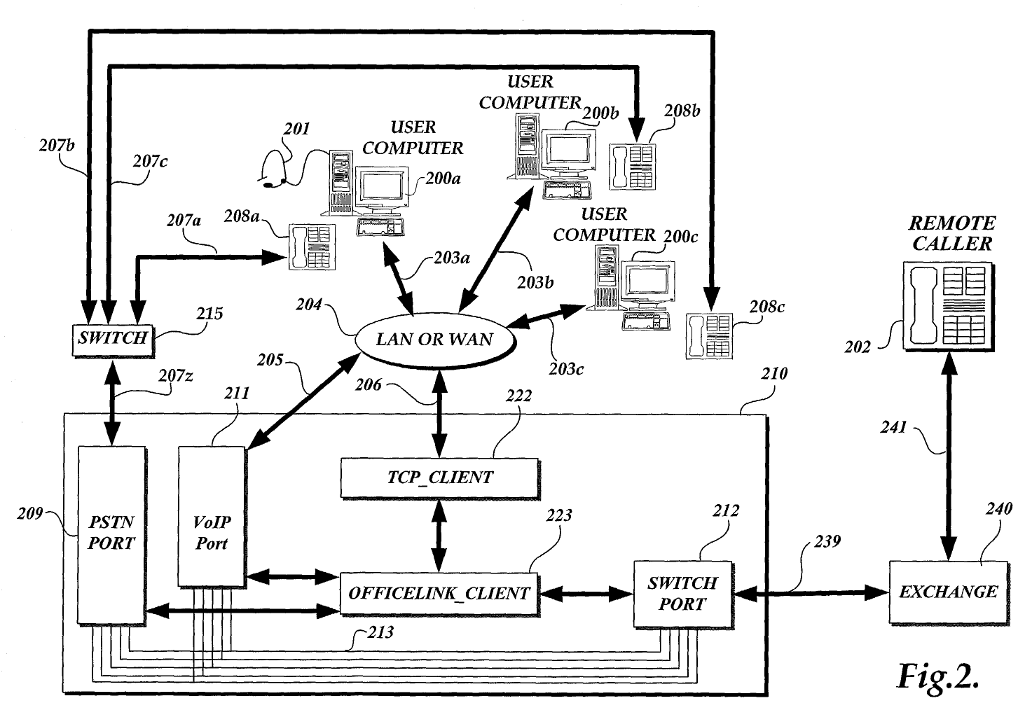

FIG. 2 illustrates an exemplary architecture of a networked telephone communication system employing the invention that includes components for both VoIP connections and PSTN connections between various telephones and computer systems. Exemplary user computers 200a, 200b, 200c are shown connected to an exemplary server computer 210 through a network 204. In an actual embodiment of the invention, multiple user computers are connected to one or more server computers via the network 204. The network 204 may be a local area network 51 (FIG. 1), a wide area network 52 (FIG. 1), or a combination of networks that allow the server computer 210 to communicate with other computers, such as the user computers 200a, 200b, 200c . . . , either directly or indirectly. The server computer 210 and the user computers 200a, 200b, 200c . . . are preferably similar to the personal computer 10 depicted in FIG. 1 and discussed above.

In the exemplary pictorial illustration shown in FIG. 2, the user computers 200a, 200b, 200c . . . are connected to the network 204 via communication links 203a, 203b, 203c suitable for carrying both voice and data. A communication link 205 is shown as connecting a hereinafter-described VoIP port 211 to the network 204. Additionally, a communication link 206 is shown connecting a hereinafter-described TCP_CLIENT program module 222 to the network 204. The TCP_CLIENT program module is shown communicating with another program module (the OFFICELINK_CLIENT program module that, in turn, communicates with and controls a switch port 212. A system bus 213, similar to the system bus 23 of FIG. 1, provides a communication link between the VoIP port 211 and the switch port 212, which is also located within the server computer 210.

The switch port 212 is linked by a communication link 239 to an exchange 240. Exchange 240 can be any communication system capable of handling typical telephone communication protocols and interfaces. Most typically, exchange 240 is a PBX. The exchange 240 is capable of establishing a connection to any telephone on the exchange network, such as remote telephone 202, via communication link 241. As will be readily appreciated by those skilled in the art and others, the exchange 204 is exemplary. In addition to being formed by a PBX, the exchange may be formed by the PSTN to by a combination of PBXs and the PSTN.

Each user computer 200 typically has an associated user telephone 208a, 208b, 208c . . . at the locations of the user computers 200a, 200b, 200c . . . . Each user telephone 208a, 208b, 208c is connected to the server computer 210 through communication links 207a, 207b, 207c . . . connected to a switch 215 that, in turn, connects by a communication link 207 to the server computer 210. The switch may be a PBX and could be formed by the exchange 240. Thus it will be appreciated that the communication path between the user telephones 208a, 208b, 208c . . . and the server 210 can be any combination of exchanges, switches, routers, computer networks or any other typical phone communication system components. Since typical telephone communication systems and components are well known, the communication path is not described further. The communication link 207d from the switch 215 is shown as connected to a hereinafter-described PSTN port 209. The PSTN port 209 is connected to the switch port 212 through the system bus 213. As described in detail below, PSTN and VoIP voice communications use various components of the system shown in FIG. 2.

FIG. 2A illustrates in more detail the VoIP channel of the communication system shown in FIG. 2. More specifically, FIG. 2A shows that the VoIP port includes two modules—a CIP channel module and a CDSP channel module, both of which are hereinafter described.

As will be readily appreciated from the foregoing description, the herein-described modules are software modules that form part of an application program or programs running on the server computer 210. The application program(s) extend the functionality of the exchange 240 to all user computers connected to the network 204 by providing features and functions of a common telephone exchange. Additionally, each user computer 200a, 200b, 200c . . . includes an application program (a VoIP client application called a soft-phone) that handles voice communication links to and from the user computer 200a, 200b, 200c . . . . A soft-phone is a graphic user interface (GUI) application that has the ability to control the voice communication between the user computer and the server computer 210. The application program running on the server computer 210 has the ability to differentiate between a PSTN voice communication link and a VoIP voice communication link.

When voice communication is to be established using the VoIP connection between one of the user computers 200a, 200b, 200c . . . and a remote telephone 202, the server computer 210 is configured to use the VoIP voice communication link. When a call is initiated at the remote telephone 202, the call is directed to the server computer 210 through the exchange 240. The server computer 210 deciphers the destination of the call (i.e., which user computer on network 204 is to receive the call) in order to establish a voice communication path. Similarly, when a call is initiated at the user computer 200, the server computer 210, which is also configured to receive calls from the user computer 200, deciphers the destination of the call (i.e., which telephone is to receive the call) in order to establish voice communication path.

While other protocols can be used, preferably, the VoIP connection between the user computer 200 and the server computer 210 uses the well-known TCP/IP protocol. The VoIP connection carries two kinds of packetized data—call control data and voice data. Since the ability to use the TCP/IP protocol to identify and communicate different kinds of data is well known in the art, this protocol is not described further herein. Call control data and voice data follow different communication paths through the server computer 210. Call control data is passed through the OFFICELINK_CLIENT program module 223 and the TCP_CLIENT program module 222. Voice data is directed by the system bus 213 to the VoIP port 212.

The establishment of the communication path for both call control and voice data depends on who initiates the call. For a call initiated by the remote telephone 202, the call signal (which is typically a pulse code modulated (PCM) signal) is sent by the exchange 240 to the switch port 212 of the server computer 210. The call destination is first determined by the server computer 210. Since the call signal is not in packetized TCP/IP form, the call signal is directed to the OFFICELINK_CLIENT program module 223 where the signal is “packetized.” The packetized call signal is directed to the TCP_CLIENT program module 222 where it is put in TCP/IP form. The packetized call signal, now in the form of TCP/IP call control data packets, is transmitted to the network 204 by the TCP_CLIENT program module 222 via the communication link 206. The call control data packets pass through the network 204 and are eventually received by the designated user computer 200a, 200b, 200c . . . . A soft-phone application program running on the destination user computer 200a, 200b, 200c . . . receives the call control data packets and indicates to the user that there is an incoming call. After the user of the destination user computer 200a, 200b, 200c . . . “answers” the soft-phone, a voice communication link is established to transmit voice data back and forth between the destination user computer 200a, 200b, 200c . . . and the calling remote telephone 202.

As was previously pointed out, voice data follows in a different communication path than call control data. After the soft-phone has answered the call, a voice communication link is established between the destination user computer 200a, 200b, 200c . . . and the calling remote telephone 202 by directing voice data from the switch port 212 to the VoIP port 211 through the system bus 213. As noted above, the VoIP port 211 has two program modules that facilitate the voice communication link—a CIP Channel program module 220 and a CDSP Channel program module 221.

The voice data is received by the CDSP Channel program module 221 where it is encoded into a form suitable for transmitting using TCP/IP. The depacketized, encoded voice data is packetized by the CIP Channel program module 220 prior to being sent to the destination user computer 200a, 200b, 200c . . . though the network 204. Call signal voice data that has been encoded and packetized is herein referred to as voice data packets. In the opposite direction, voice data packets produced by the soft-phone application running on the destination user computer 200a, 200b, 200c . . . and received by the server computer 210 are depacketized by the CIP Channel program module 220. The resulting depacketized encoded voice data is decoded by the CDSP Channel program module 221 into forwardable (i.e., PCM) voice signals. The PCM signals are directed by the system bus 213 to the switch port 212. The switch port 212 forwards the PCM voice signals to the exchange 240 which forwards the PCM signals to the calling remote telephone 202 Since PCM encoding and decoding of telephone voice signals is well known in the art, it is not discussed here. A voice communication link is now established using the VoIP connection.

When a call is initiated by the soft-phone application running on a user computer 200a, 200b, 200c . . . , call control data packets are first generated and sent by the calling user computer 200a, 200b, 200c . . . to the server computer 210. The call control data packets are received by the TCP_CLIENT program module 222. The call control data packets, which are in TCP/IP form, are depacketized by the TCP_CLIENT program module 222. The depacketized call control data is converted by the OFFICELINK_CLIENT program module 223 into a call signal. The call signal is transmitted to the remote telephone 202 being called via the switch port 212 and the exchange 240. A voice communication link is established when the called remote telephone 202 is answered. Thereafter, voice data can be transmitted between the calling user computer 200a, 200b, 200c . . . and the called remote telephone 202.

As before, voice data packets produced by the calling user computer 200a, 200b, 200c . . . and received by the server computer 210 are depacketized by the CIP Channel program module 220. The depacketized encoded voice data is decoded by the CDSP Channel program module 221 and converted into a forwardable telephone (i.e., PCM) signal. The PCM signal is transmitted via the system bus 213 to the switch port 212 which forwards the PCM signal to the exchange 240. The exchange 240 forwards the PCM signal to the called remote telephone 202. PCM signals produced by the called remote telephone 202 are sent by the exchange 240 to the switch port 212. The switch port 212 forwards the PCM signals, via the system bus 213, to the CDSP channel program module 221, which encodes the PCM signals. The depacketized encoded PCM signals are packetized by the CIP Channel program module 220 and sent to the calling remote user computer 200a, 200b, 200c . . . through the network 204.

As noted above, embodiments of the present invention have the ability to switch fluidly between a VoIP connection and a PSTN connection without losing the continuity of the connection between the communicating user computer 200a, 200b, 200c . . . and the remote telephone 202, i.e., without dropping the call. A voice communication link that is currently a VoIP connection can be switched to a PSTN connection. Alternatively, a voice communication link that is currently a PSTN connection can be switched to a VoIP connection. The first switching process to be described below is the VoIP connection to a PSTN connection switching process.

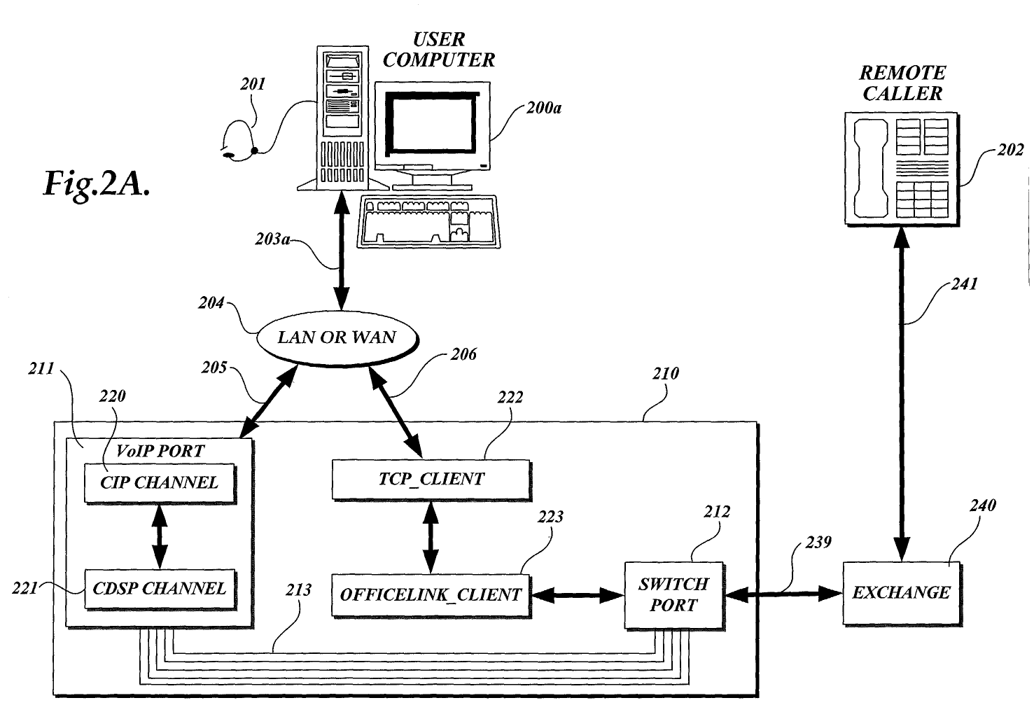

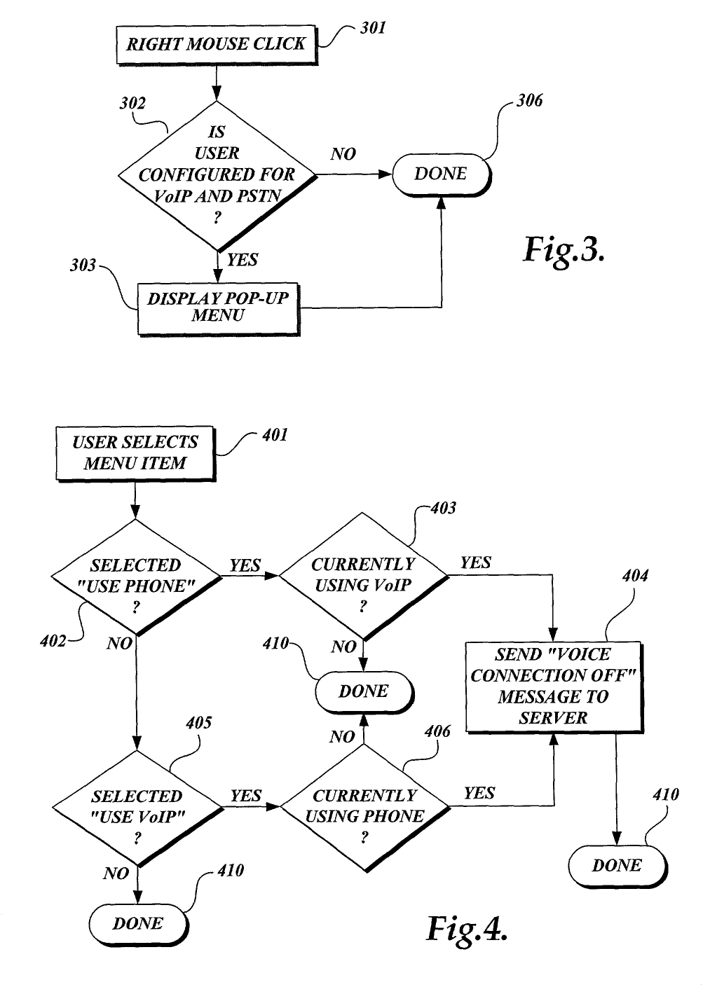

In accordance with this invention, the user of the communicating user computer 200 uses the soft-phone application running on the user computer 200a, 200b, 200c . . . to initiate a switch from a VoIP connection to a PSTN connection. This is accomplished by attempting to enable the display of a pop-up menu and choosing a “Use Phone” command. The soft-phone application first confirms that the system is capable of handling the request, and if capable, enables the pop-up menu. After the “Use Phone” selection is made, the soft-phone application sends a message to the server computer 210 to change from a VoIP connection to a PSTN connection. Flow diagrams illustrating these logical processes are shown in FIG. 3 and FIG. 4.

FIG. 3 is a flow chart illustrating the process of checking the configuration of the system. Upon receipt of a user input, such as, for example, a right mouse click 301, the soft-phone determines, in step 302, if the communicating user computer 200a, 200b, 200c . . . is configured for both VoIP and PSTN. If the communicating user computer is not configured for both VoIP and PSTN, the pop-up menu is not displayed and the process is terminated as shown in step 306. If the communicating user computer 200a, 200b, 200c . . . is configured for both VoIP and PSTN, the pop-up menu is displayed as shown in step 303. The user is presented with various choices, which are described below with respect to FIG. 4. The pop-up menu is displayed until either the user makes a selection or the pop-up menu is closed by some other well-known action, such as, for example, placing the mouse cursor in a screen location and activating (clicking) the appropriate mouse button.

FIG. 4 is a flow chart illustrating the process for responding to a user's input once it has been determined (FIG. 3) that a particular user computer 200 has been configured for both VoIP and PSTN and the pop-up menu is displayed. The pop-up menu displays several menu items. Among the choices are “Use Phone” and “Use VoIP.” At step 401, the user selects a particular menu item. At step 402, the soft-phone application determines whether or not the user has selected the “Use Phone” item. If the user has selected “Use Phone,” the process moves to step 403 where a test is made to determine if the user computer is currently using a VoIP connection. If the user computer 200 is not currently using a VoIP connection, the user computer 200 must be using a PSTN connection. Thus, no change is necessary. As a result, the process terminates at step 410. If the user computer 200 is currently using a VoIP connection, a change in the voice communication link is required. As a result, the process moves to step 404 where a “voice connection off” message is sent to the server computer 210. Once the “voice connection off” message has been sent to the server computer 210, the process terminates at step 410.

If the “Use Phone” test, step 402, is answered in the negative, the process proceeds to step 405 where a test is made to determine if “Use VoIP” has been selected from the pop-up menu. If “Use VoIP” has been selected, the process moves to step 406. At step 406, a test is made to determine if the user computer 200 is currently using a PSTN connection. If the user computer 200 is not currently using a PSTN connection, the process terminates at step 410. If it is determined that the user computer 200 is currently using a PSTN connection, a change in the voice communication link is required. As a result, again, at step 404, a “voice connection off” message is sent to the server computer 210. After the “voice connection off” message has been sent to the server computer 210, the process terminates at step 410. The process also terminates at step 410 if the user has not selected either “Use Phone” or “Use VoIP” in the pop-up menu.

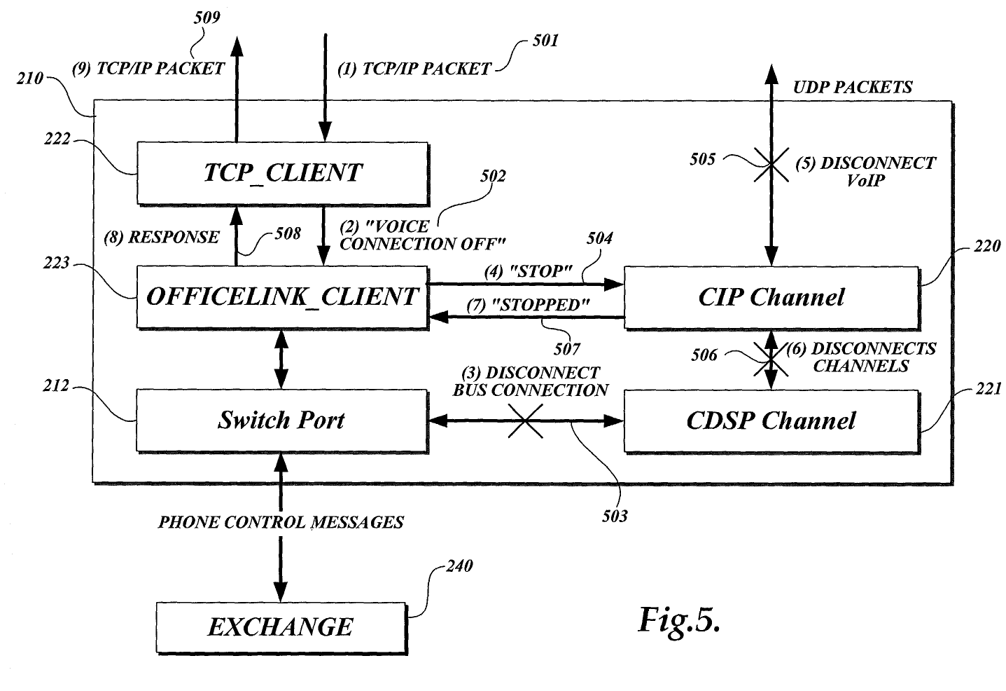

The “voice connection off” message sent to the server computer triggers a number of steps that cause the existing communication path to be torn down and a new and different communication path to be built. FIG. 5 is a pictorial representation of the steps involved in terminating a VoIP connection at the server computer 210 when a “voice connection off” message is received by the server computer 210. For ease of following the following description, the sequence of steps is shown by numbers in parentheses. When the soft-phone application running the communicating user computer 200a, 200b, 200c . . . sends a “voice connection off” message to the application server 210, the message is sent 501 in TCP/IP form to the TCP_CLIENT program module 222. This is step (1). The “voice connection off” message is de-packetized by the TCP_CLIENT program module 222 and sent 502 to the OFFICELINK_CLIENT program module 223. This is step (2). In response to the “voice connection off” message, the OFFICELINK_CLIENT program module 223 disconnects 503 the CDSP Channel program module 221 from system bus 213 and, thus, from the switch port 212. This is step (3). The OFFICELINK_CLIENT program module 223 then sends a “stop” message 504 to the CIP Channel program module 220. This is step (4). In response to the “stop” message, the CIP Channel program module 220 disconnects 503 the VoIP connection between the server computer 210 and the communicating user computer 200a, 200b, 200c . . . . This is step (5). Then the CIP Channel program module 220 is disconnected from the CDSP Channel program module 221. This is step (6). After the VoIP connection has been disconnected, the CIP Channel program module 220 sends 507 a “stopped” message back to the OFFICELINK_CLIENT program module 223. This is step (7). A “voice connection off” response message is generated by the OFFICELINK_CLIENT program module 223 and sent 508 to the TCP_CLIENT program module 222. This is step (8). The “voice connection off” response message is put into TCP/IP form by the TCP_CLIENT program module 222 and sent 509 to the communicating user computer 200a, 200b, 200c . . . . This is step (9). If at any step, a failure occurs, a “voice connection off failed” message (not shown) is sent to the communicating user computer 200a, 200b, 200c . . . .

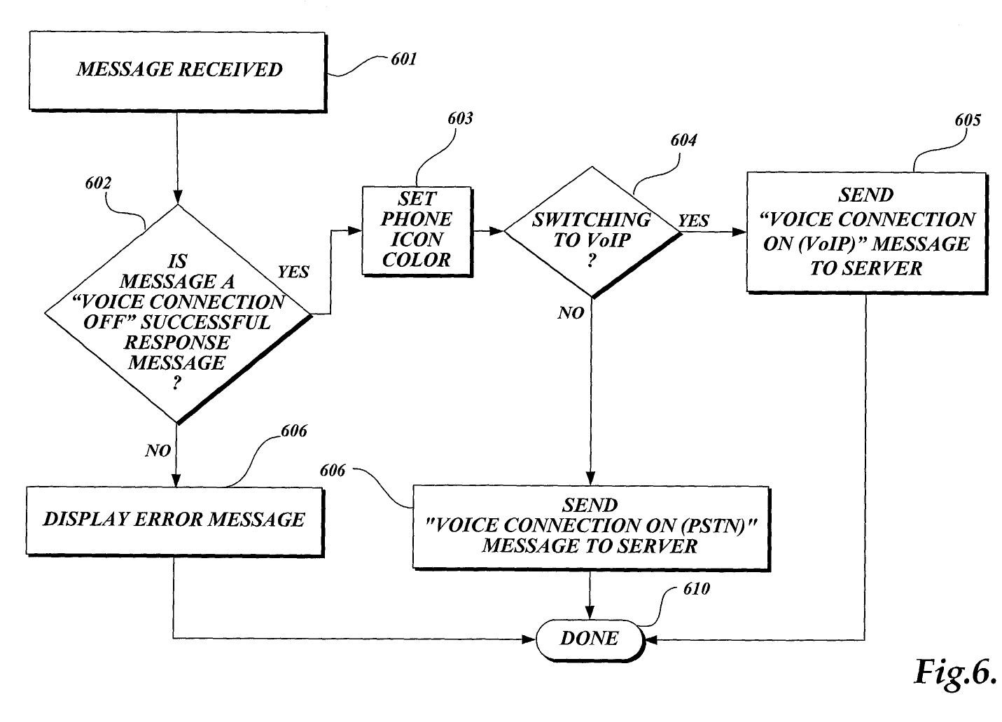

FIG. 6 is a flow chart of the process followed by the soft-phone application running on the communicating user computer 200a, 200b, 200c . . . upon receiving a “voice connection off” response message or a “voice connection off failed” message. At step 601, the message is received by the communicating user computer 200a, 200b, 200c . . . . In step 602, a test is made to determine if the message is a “voice connection off” response message. If the message from the server computer 210 is not a “voice connection off”0 response message, but instead is a “voice connection off failed” message, an error message is displayed on the communicating user computer 200a, 200b, 200c . . . (step 606) and the process terminates (step 610). The switching process stops at that point. If the VoIP connection cannot be dropped, another connection will not be established.

If the message from the server computer 210 received by the communicating user computer 200a, 200b, 200c . . . is a “voice connection off” response message, a phone icon controlled by the soft-phone application running on the user computer 200 will change color, e.g., turn blue (step 603). The blue phone icon indicates to the user that there is no VoIP connection. (When a VoIP connection is present, the phone icon has a different color, e.g., green.)

At step 604, the soft-phone application determines if the server computer 210 is in the process of changing to a VoIP connection. If the server computer is in the process of switching to a VoIP connection, the soft-phone application running on the user computer 200 sends a “voice connection on (VoIP)” message to the server computer (step 605). The process then terminates at step 610. If the server computer is not in the process of switching to a VoIP connection, the soft-phone application running on the user computer 200 sends a “voice connection on (PSTN)” message to the server computer (step 606). Then the process terminates at step 610. (Since the current example is switching from a VoIP connection to a PSTN connection, the soft-phone application running on the communicating user computer 200a, 200b, 200c . . . sends a “voice connection on (PSTN)” message to the server computer.) In response to the receipt of a “voice connection on” message, either PSTN or VoIP, from the communicating user computer 200a, 200b, 200c . . . , the server computer 210 creates the applicable communication port. More specifically, when the server computer 210 receives the “voice connection on” message, the OFFICELINK_CLIENT program module 223 creates a port of the appropriate type. For the current example of switching from a VoIP connection to a PSTN connection, the OFFICELINK_CLIENT program module 223 creates a PSTN port. For the case in which the switch is from a PSTN connection to a VoIP connection, the OFFICE_LINK program module 223 would create a VoIP Port (which contains the CIP channel 220 and the CDSP channel 221).

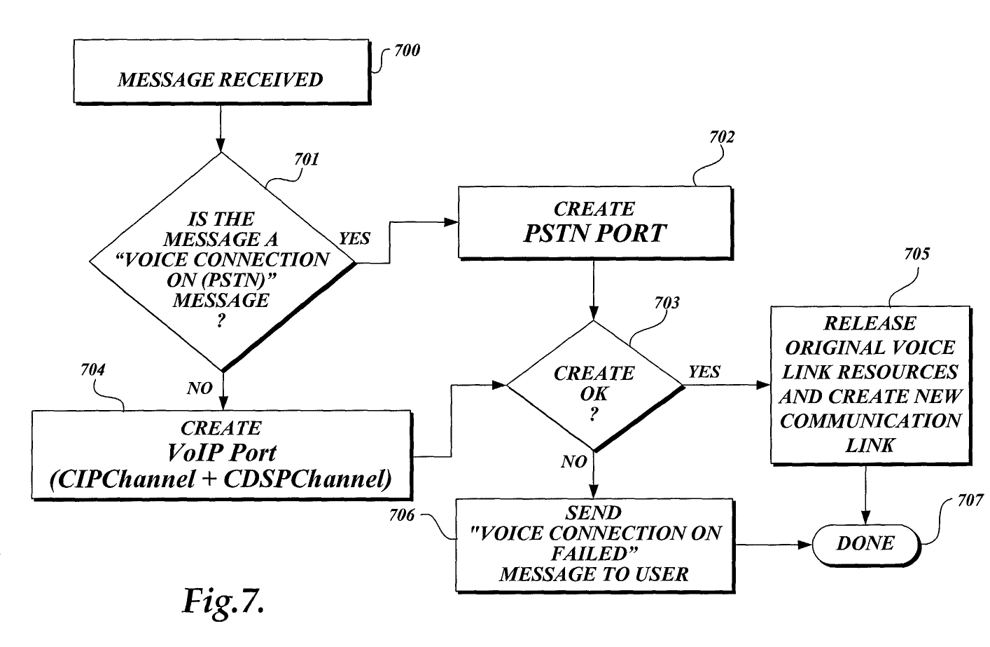

FIG. 7 is a flow chart showing the process followed by the server computer 210 when creating the appropriate voice communication link port discussed above. In step 700, the message is received by the OFFICELINK_CLIENT program module 223. At this point, the received message has been depacketized by the TCP_CLIENT program module 222. Next the process determines whether the message is a “voice connection on (PSTN)” message (step 701). If the message is a “voice connection on (PSTN)” message, the process proceeds to step 702. At step 702, a PSTN port software object is created by the server computer 210. In the current example, the switch is from a VoIP connection to a PSTN connection; thus, this is the logical path the process follows. Alternatively, where the switch is from a PSTN connection to a VoIP connection, at step 702, the process determines that the message is not a “voice connection on (PSTN)”. In this case, the process proceeds to step 704. At step 704, a VoIP port software object is created by the server computer 210.

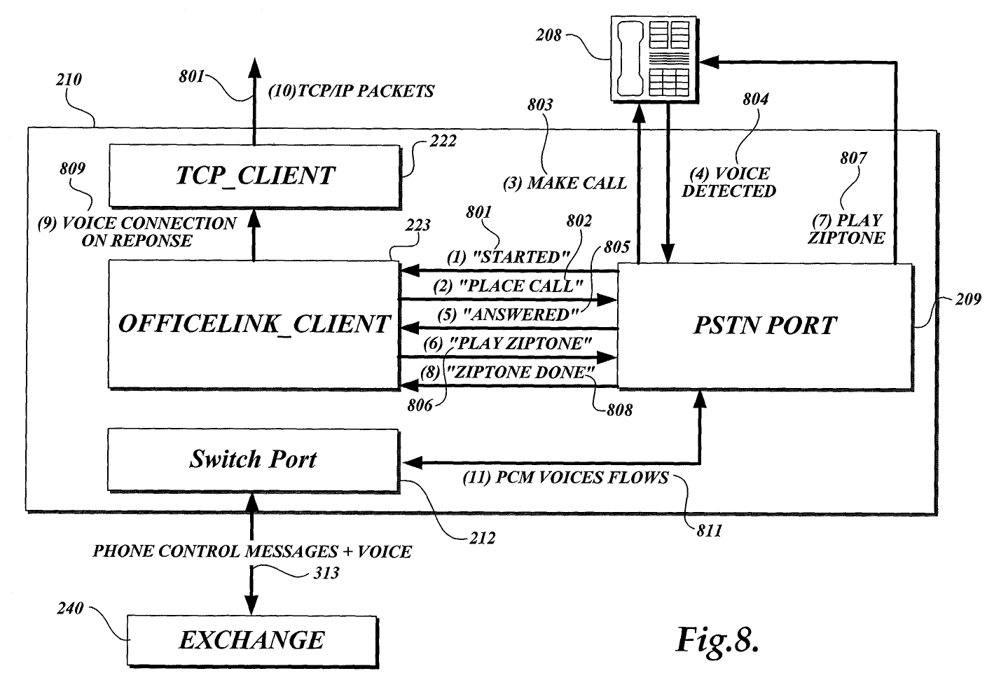

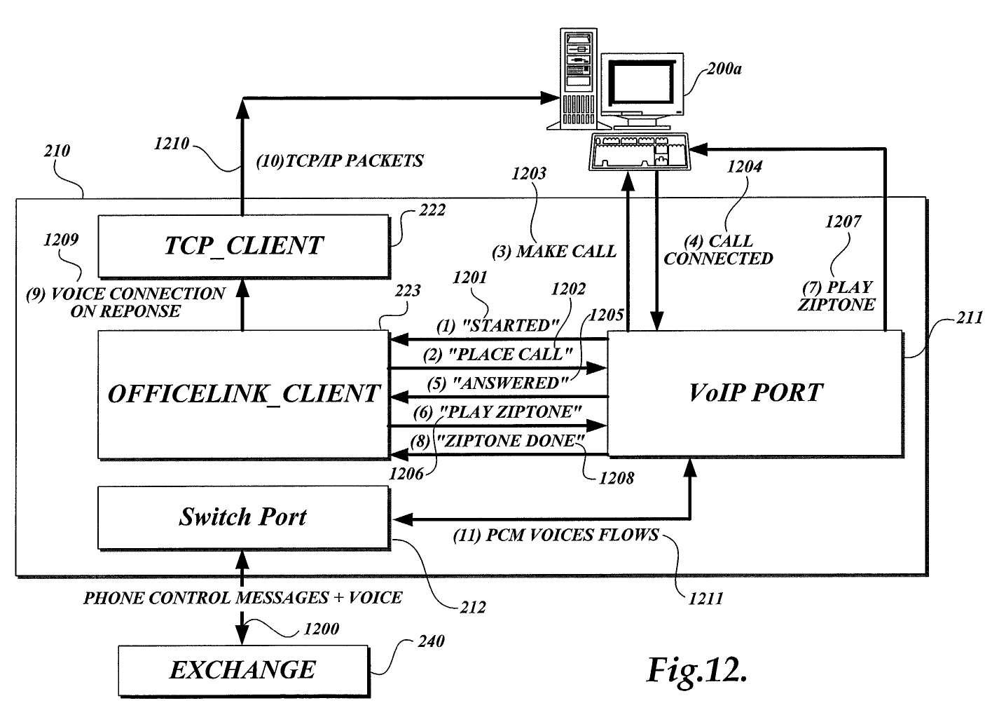

Regardless of which type of port is created, the process proceeds to step 703 where a test is made to determine if the creation of the port software object (either PSTN or VoIP) was successful. If the port software object was not created, the process proceeds to step 706 and a “voice connection on failed” message is sent to the communicating user computer 200a, 200b, 200c . . . . The process then terminates at step 707. If the port software object was created, the process proceeds to step 705 where the original voice communication link resources are released and a voice communication link is established (by the newly created port software object). The process followed by the server computer when establishing a PSTN connection is illustrated in FIG. 8 and described below with respect to FIG. 8. The process followed by the server computer when establishing a VoIP connection is illustrated in FIG. 12 and is described below with respect to FIG. 12. After the appropriate process is finished, the process illustrated in FIG. 7 terminates at step 707.

As noted above, FIG. 8 illustrates (in pictorial form) the process followed by the server computer when establishing or reestablishing a PSTN connection between the server computer 210 and the communicating user computer 200a, 200b, 200c . . . . After creation (step 702, FIG. 7), the newly created PSTN port 800 is “started.” More specifically, the PSTN port 209 causes the trunk protocol (loop start or wink start for T1) to start. When this occurs, the PSTN port 209 sends 801 a “started” message to the OFFICELINK_CLIENT program module 223. This is illustrated as step (1) in FIG. 8. The OFFICELINK_CLIENT program module 223 receives the “started” message and responds 802 by sending a “place call” message back to the PSTN port 209. This is step (2) of FIG. 8. The PSTN port 209 identifies the user telephone 208a, 208b, 208c . . . associated with the previously communicating user computer 200a, 200b, 200c . . . location and places a call 803 to the phone number of that telephone 208a. This is step (3). When a user answers the called telephone 208a, the user's voice is detected 804 by the PSTN port 209. This is step (4). The PSTN port 209 then sends 805 an “answered” message to the OFFICELINK_CLIENT program module 223. This is step (5). In response, the OFFICELINK_CLIENT program module 223 plays 806 a zip tone, which initiates a communication path between the OFFICELINK_CLIENT program module 223 and the PSTN port 209. This is step (6). The zip tone is forwarded 807 to the user's telephone as shown by step (7). After the zip tone has been sent to the user's telephone 208a, the PSTN port 209 sends 808 a “zip tone done” message to the OFFICELINK_CLIENT program module 223, as shown by step (8). A voice communication link has now been established between the server computer 210 and the user's telephone 208a associated with the previously communicating user computer 200a, 200b, 200c . . . via a PSTN connection. Next the OFFICELINK_CLIENT program module 223 sends a “voice connection on” response message back to the previously communicating user computer 200a, 200b, 200c . . . . More specifically, the “voice connection on response” message is sent 809 from the OFFICELINK_CLIENT program module 223 to the TCP_CLIENT program module 222. This is step (9) The TCP_CLIENT program module 222 packetizes the “voice connection on response” message and sends 801 the message over the network 204 to the previously communicating user computer 200a, 200b, 200c . . . , as illustrated by step (10). Finally, the PSTN port 209 establishes 811 a communication connection back to the switch port 212 via the system bus 213. This is step (11) and completes the PSTN connection. Step (11) illustrates that PCM voice signal flow from the user telephone 208a through the newly created PSTN port 209 to the switch port 212, then to exchange 240, and ultimately to the remote telephone 202. If, at any point during this process, a failure occurs, a “voice connection on failed” message is sent to the previously communicating user computer 200a, 200b, 200c . . . .

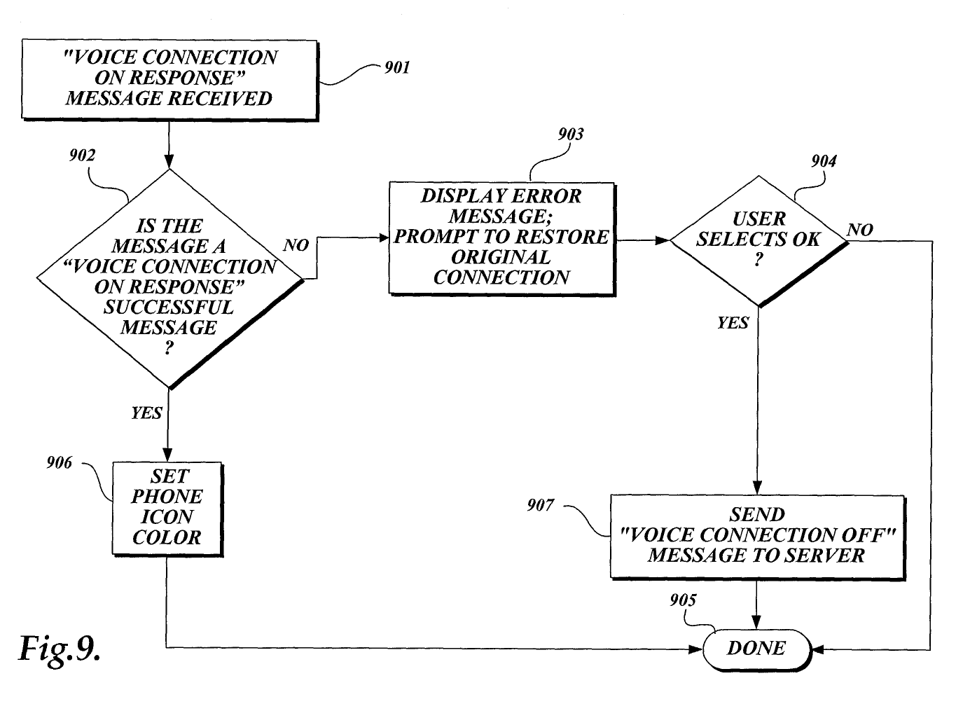

After receiving the “voice connection on” response message generated at step (9)of FIG. 8 and sent to the communicating user computer at step (10), the soft-phone application running on the previously communicating user computer 200a, 200b, 200c . . . follows the logic depicted in FIG. 9. First, the message is received at step 901. At step 902, a test is made to determine if the message is a “voice connection on” response message. If the message is a “voice connection on” response message, the process proceeds to step 906 and the phone icon on the soft-phone application is colored its PSTN color, i.e., blue. The process then terminates at step 905. If the message is not a “voice connection on” response message, the message is a “voice connection on failed” message. In this event, an error message is displayed by the soft-phone application. See step 903. Preferably, the error message display includes a prompt and a soft key that allows a user to choose to restore the original voice communication link between the previously communicating user computer 200a, 200b, 200c . . . and the remote telephone 202. In this particular example, the choice presented the user would be to reestablish the VoIP connection.

If the user chooses not to restore the original connection, the process terminates at step 905. Selecting not to restore the original connection results in the voice communication link between user computer 200 and remote telephone 202 being completely terminated. If the user chooses to restore the original connection, the process required to reestablish a voice communication link between the previously communicating user computer 200a, 200b, 200c . . . and the remote telephone 202 is started. This process is initiated at step 907 where the previously communicating user computer 200a, 200b, 200c . . . sends a “voice connection off” message to the server computer 210, as occurred at step 404 in FIG. 4. After this message is sent, the process illustrated in FIG. 9 terminates at step 905. As will be understood from the following description, the “voice connection off” message initiates a switch back to a VoIP connection. The particular steps that occur when switching from a PSTN connection to a VoIP connection are discussed in detail below.

The foregoing discussion describes in detail the process of switching from a VoIP connection to a PSTN connection. The reciprocal situation, i.e., switching from a PSTN connection to a VoIP connection, is accomplished by this invention. As noted above, FIG. 2 illustrates an exemplary network communication system architecture in which the present invention operates.

As also previously noted, FIG. 2 depicts a PSTN connection between a user telephone 208a, 208b, 208c . . . and a remote telephone 202. At this point, it is assumed that a PSTN connection between a telephone 208a, 208b, 208c . . . associated with one of the user computers 200a, 200b, 200c . . . and the remote telephone 202 exists and that the user wants to change to a VoIP connection. This change is initiated by the user selecting “Use VoIP” from a pop-up menu displayed by the soft-phone application running on the user computer. Thereafter the processes shown in FIGS. 3 and 4 and described above occur. As a result, a “voice connection off” message is sent to the server.

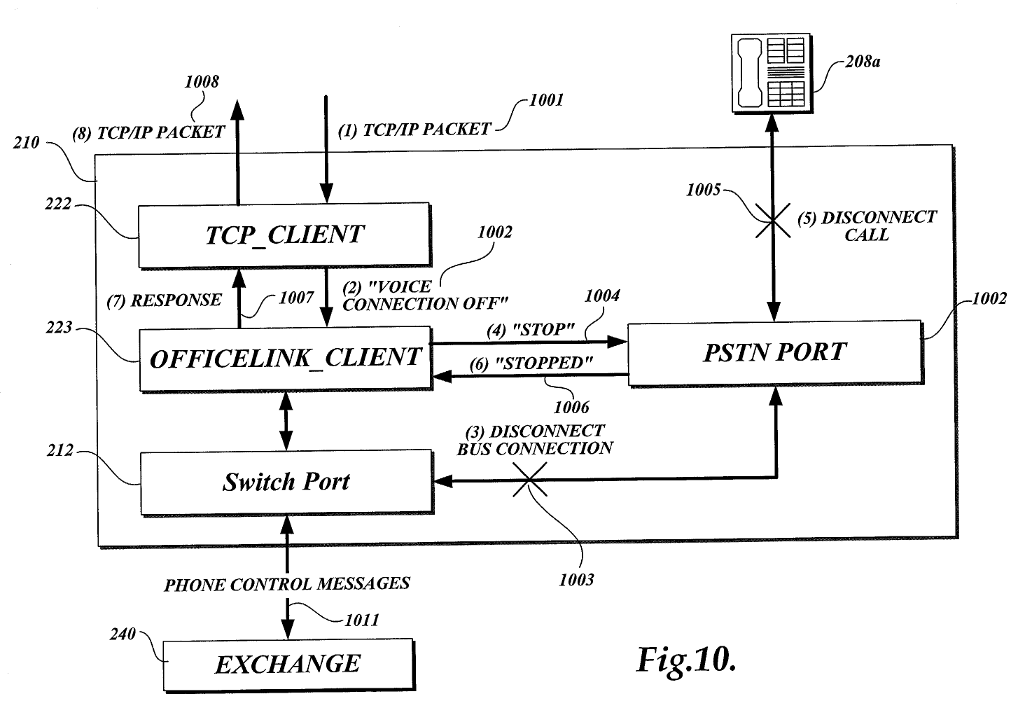

The “voice connection off” message triggers a number of steps that cause the PSTN communication link to end and a VoIP communication link to be created. FIG. 10 is a pictorial representation of the steps involved in terminating a PSTN connection between the server computer 210 and a user telephone 208a, 208b, 208c . . . when a “voice connection off” message is received by the server computer210. The “voice connection off” message is sent 1001 via TCP/IP packets, as illustrated by step (1). The “voice connection off” message is received by the TCP_CLIENT program module 222. The “voice connection off” message is depacketized by the TCP_CLIENT program module 222 and sent 1002 to the OFFICELINK_CLIENT program module 223, as illustrated by step (2). In response to receiving the “voice connection off” message, the OFFICELINK_CLIENT program module 223 disconnects 1003 the bus connection between the PSTN port 209 and the switch port 212, as illustrated by step (3). After the bus connection has been disconnected, the OFFICELINK_CLIENT program module 223 sends 1004 a “stop” message to the PSTN port 209, as illustrated by step (4). The “stop” message causes the PSTN port 209 to disconnect 1005 the connection between the PSTN port 209 and the user telephone 208a, as illustrated by step (5). After this disconnection has occurred, the PSTN port 209 sends 1006a “stopped” message back to the OFFICELINK_CLIENT program module 223, as illustrated by step (6). The “stopped” message causes the OFFICELINK_CLIENT program module 223 to send 1007 a “voice connection off” response message to the TCP_CLIENT program module 222, as shown by step (7). The TCP_CLIENT program module 222 packetizes the “voice connection off” response message. The TCP/IP packets containing the “voice connection off” response message are sent 1008 to the pertinent user computer 200a, 200b, 200c . . . as shown by step (8). If at any time during the foregoing process, a failure occurs, a “voice connection off failed” message is sent to the pertinent user computer 200a, 200b, 200c . . . .

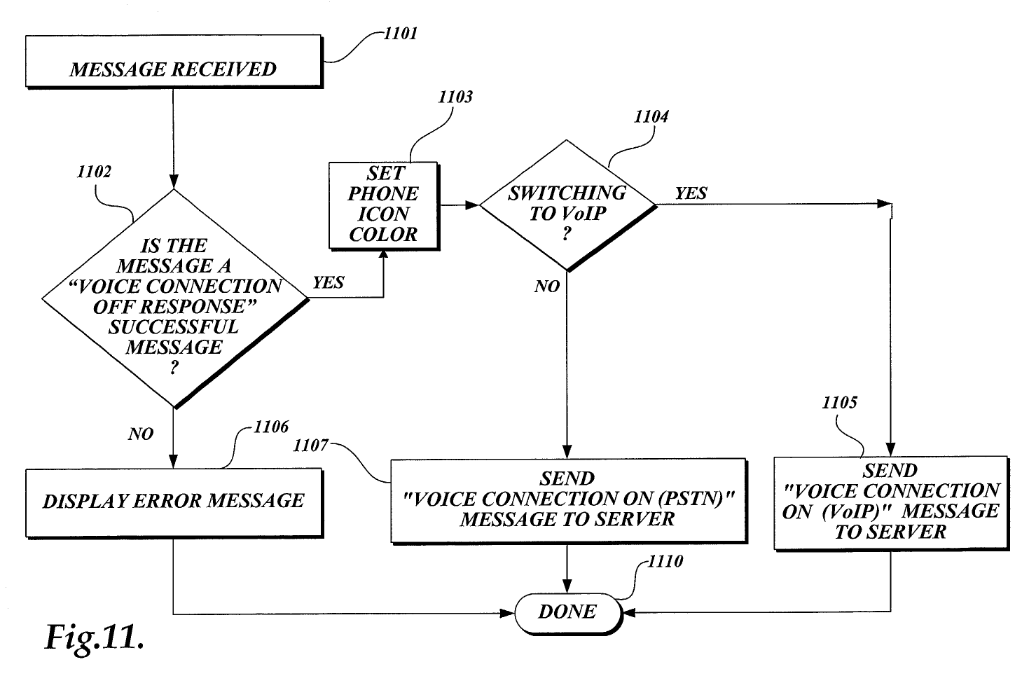

FIG. 11 is a flow chart illustrating the process that soft-phone application of the pertinent user computer 200a, 200b, 200c . . . follows when a “voice connection off” response message is received. After receiving a message from server computer 210 (step 1101), the user computer determines if the message is a “voice connection off” message. See step 1102. If the message is not a “voice connection off” response message, an error message is displayed (step 1106). Because the PSTN connection was not able to be disconnected, the process illustrated in FIG. 11 then terminates at step 1210. As a result, the original voice communication link via the PSTN connection persists.

If, at step 1202, the user computer determines that a “voice connection off” response message was received, the process proceeds to step 1103. At step 1103, the phone icon color is changed to blue. Then a test is made to determine if the server computer 210 is in the process of switching to a VoIP connection. See step 1104. If the server computer is in the process of switching to a VoIP connection, the soft-phone application process proceeds to step 1105 and a “voice connection on (VoIP)” message is sent to the server computer 210. If the server computer is not in the process of switching to a VoIP connection, the soft-phone application process proceeds to step 1107 and a “voice connection on (PSTN)” message is sent to the server computer 210. After the “voice connection on (VoIP or PSTN)” message has been sent to the server computer 210, the process terminates at step 1110.

The server computer 210 follows the logical steps illustrated in FIG. 7 in response to receiving a “voice connection on” message from the user computer whether it be for a PSTN connection establishment or a VoIP connection establishment. Since this logic was previously described, the logic is not described here except to note that after a VoIP port is created (step 704, FIG. 7), the original PSTN connection resources are released and the steps to establish a voice communication link between the pertinent user computer 200a, 200b, 200c . . . and the server computer 210 via a VoIP connection are carried out.

FIG. 12 is a pictorial representation of the steps involved in establishing a VoIP connection between the server computer 210 and a user computer 200a, 200b, 200c . . . after a VoIP port 211 has been created by the server computer (step 704, FIG. 7). As previously described, the VoIP port 211 contains a CIP channel program module 220 and a CDSP Channel program module 221. Since these program modules were described previously, they are not shown in FIG. 12 and are not described further.

After being created, the VoIP port 211 sends 1201 a “started” message to the OFFICELINK_CLIENT program module 223, as illustrated by step (1). In response, the OFFICELINK_CLIENT program module 223 sends 1202 a “place call” message back to the VoIP port 211, as illustrated by step (2). A VoIP call is then placed 1203 from the VoIP port 211 to the appropriate user computer 200a, 200b, 200c . . . as illustrated by step (3). When the operator of the user computer answers the VoIP call using the soft-phone application running on the user computer 200, the resulting voice signal is detected 1204 by the VoIP port 211, as illustrated at step (4). The VoIP port 211 forwards 1205 the “answered” message to the OFFICELINK_CLIENT program module 223, as illustrated at step (5). The OFFICELINK_CLIENT program module 223 responds to the “answered message” by sending 1206 a “play zip tone” message to the VoIP port 211. See step (6). The VoIP port generates and sends 1207 a zip tone to the user computer 200 over the new voice communication link, as illustrated by step (7). After the zip tone has been sent, the VoIP port 211 sends 1208 a “zip tone done” message back to the OFFICELINK_CLIENT program module 223, as illustrated by step (8). The “zip tone done” message signals to the OFFICELINK_CLIENT program module 223 that it can now send a “voice connection on” response message back to the pertinent user computer 200a, 200b, 200c . . . . The “voice connection on” response message is sent 1209 from the OFFICELINK_CLIENT program module 223 to the TCP_CLIENT program module 222. See step (9). The TCP_CLIENT program module 222 packetizes the “voice connection on” response message and sends 1210 the TCP/IP packets to the pertinent user computer 200a, 200b, 200c . . . as shown by step (10). A VoIP connection has now been established between the pertinent user computer 200a, 200b, 200c . . . and the remote telephone 202. PCM voice messages can now flow 1211 from the pertinent user computer 200a, 200b, 200c . . . through the VoIP port 211 over the system bus 213 to the switch port 212, then to exchange 240 and eventually to the remote telephone 202, as illustrated by step (11). If at any time during the foregoing process a failure occurs, a “voice connection on failed” message is sent to the pertinent user computer 200a, 200b, 200c . . . .

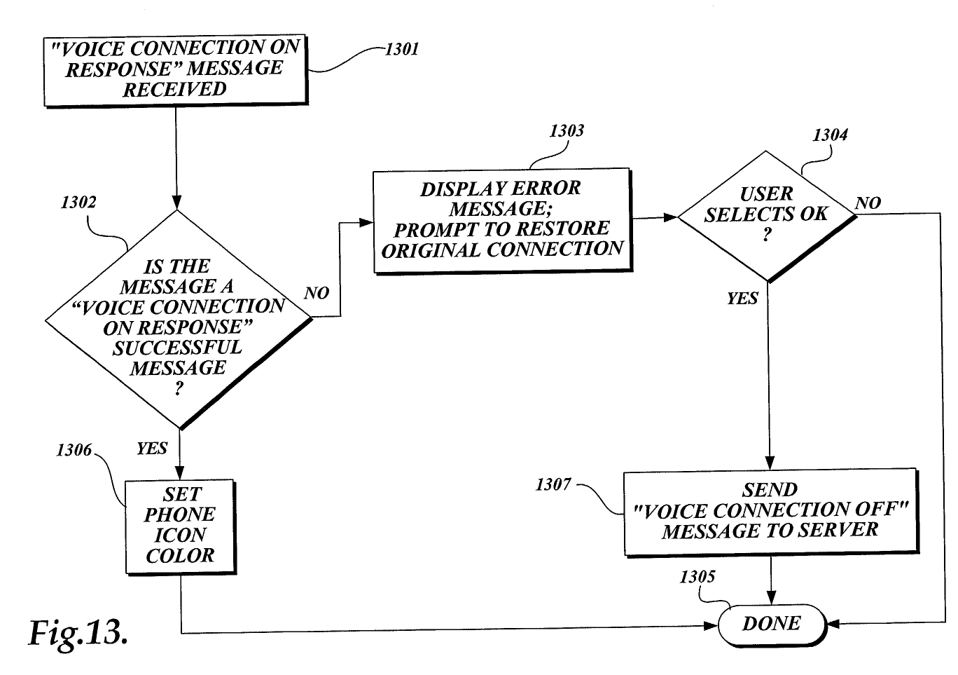

FIG. 13 is a flow chart illustrating the process that the soft-phone application running on the user computer 200a, 200b, 200c . . . after receiving a “voice connection on” response message from the server computer 210 (step 1210, in FIG. 2). At step 1301, the message is received. At step 1302, the user computer 200 determines if the message is a “voice connection on” response message. If the message is a “voice connection on” response message, the process proceeds to step 1306 and the phone icon on the soft-phone application turns green to indicate that a VoIP connection has been established. The process then terminates at step 1305. If the message received is not a “voice connection on” response message, the process proceeds to step 1303. At step 1303, an error message is displayed. In addition, the user is prompted to choose to restore the original voice communication link between the pertinent user computer 200a, 200b, 200c . . . and the remote telephone 202. In this particular example, the user would be prompted to reestablish the PSTN connection. If the user chooses not to restore the original connection, the process terminates at step 1305. Selecting not to restore the original connection results in the voice communication link between pertinent user computer 200a, 200b, 200c . . . and the remote telephone 202 being completely terminated. If the user chooses to restore the original connection, the PSTN communication link between the pertinent user telephone 208a, 208b, 208c . . . and remote telephone 202 is established in the manner described above. This action is initiated at step 1307 by the pertinent user computer 200a, 200b, 200c . . . sending a “voice connection off” message to the server computer 210 (step 404, FIG. 4). After this message has been sent, the process illustrated in FIG. 13 terminates at step 1305.

While the preferred embodiment of the invention has been illustrated and described, it will be appreciated that within the appended claims various changes can be made therein without departing from the spirit and scope of the invention.

The embodiments of the invention in which an exclusive property or privilege is claimed are defined as follows:

1. A method of allowing a user to selectively control voice communication over a voice over Internet protocol (VoIP) connection path and a public switched telephone network (PSTN) connection path comprising:
(a) establishing a voice communication link over either a VoIP connection path between a user computer and a remote telephone or a PSTN connection path between a user telephone and the remote telephone, the established voice communication link controlled by a server computer, and
(b) in response to receiving, at the user computer, a request from a user to change the established voice communication link, the server computer:
(i) disconnecting the established voice communication link; and
(ii) creating an alternative voice communication link over the other of the VoIP connection path between the user computer and the remote telephone or the PSTN communication path between the user telephone and the remote telephone.

2. The method of claim 1 further comprising, in response to receiving at the user computer, a request from a user to reestablish the established voice communication link in the event the server computer fails to create the alternative voice communication link, the server computer reestablishing the established voice communication link.

3. The method of claim 1 wherein the user computer includes a soft-phone application having a user interface for receiving user inputs.

4. The method of claim 3 wherein the user interface includes a phone icon the color of which is determined by whether the active voice communication link is the established voice communication link or the alternative voice communication link.

5. The method of claim 1 wherein the user computer includes a soft-phone application having a user interface for receiving user inputs.

6. The method of claim 5 wherein the user interface includes a phone icon the color of which is determined by whether the active voice communication link is the established voice communication link or the alternative voice communication link.

7. The method of claim 1 wherein the server computer includes an application program that selectively produces a PSTN port object and a VoIP port object depending on whether the active voice communication link is the established voice communication link or the alternative voice communication link.

8. The method of claim 7 wherein the VoIP port object includes a first module for encoding telephone voice signals into a form suitable for transmission using a predetermined protocol and a second module suitable for packetizing the encoded telephone voice signals prior to transmission to the user computer.

9. The method of claim 8 wherein said second module also depacketizes encoded telephone voice signals received from the user computer and said first module also decodes the depacketized encoded telephone voice signals.

10. The method of claim 7 wherein said application program includes a first program module for placing call control signals in a form suitable for packetizing and a second program module for packetizing the call control signals.

11. The method of claim 10 wherein the second program module also depacketizes call control signals and the first program module converts the depacketized call controls signals into call control signals.

12. A method of controlling a user computer included in a communication system that allows a user to selectively control voice communication over a voice over Internet protocol (VoIP) connection path and a public switched telephone network (PSTN) connection path comprising:
causing the user computer to display a graphical user interface suitable for receiving user input allowing a user to choose between a VoIP connection path and a PSTN connection path;
in response to a user input designating a VoIP connection path, sending a message to a server computer that identifies the VoIP connection path as the user's choice; and
in response to a user input designating the PSTN connection path, sending a message to the server computer that identifies the PSTN connection path as the user's choice.

13. The method of claim 12 wherein the graphical user interface includes a phone icon the color of which is dependent upon the connection path chosen by the user.

14. The method of claim 12 including determining if the user computer is configured for both a VoIP connection path and a PSTN connection path.

15. The method of claim 12 wherein the user computer sends a voice connection off message to the server computer if the connection path other than the connection path chosen by the user is in use when the user makes a choice.

16. A method of controlling a server computer included in a communication system that allows a user to selectively control voice communication over a voice over Internet protocol (VoIP) connection path and a public switched telephone network (PSTN) connection path comprising:
in response to the server computer receiving a message from a user computer designating the use of a VoIP connection path, creating a VoIP port object for controlling voice communication over said VoIP connection path; and
in response to the server computer receiving a message from a user computer designating the use of a PSTN connection path, creating a PSTN port object for controlling voice communication over said PSTN connection path.

17. The method of claim 16 wherein the VoIP port object includes a first module for encoding telephone voice signals into a form suitable for transmission using a predetermined protocol and a second module suitable for packetizing the encoded telephone voice signals prior to transmission to the user computer.

18. The method of claim 17 wherein said second module also depacketizes encoded telephone voice signals received from the user computer and said first module also decodes the depacketized encoded telephone voice signals.

19. The method of claim 16 wherein said application program includes a first program module for placing call control signals in a form suitable for packetizing and a second program module for packetizing the call control signals.

20. The method of claim 19 wherein the second program module also depacketizes call control signals and the first program module converts the depacketized call controls signals into call control signals.

21. A voice communication system having a voice over Internet protocol (VoIP) connection path and a public switched telephone network (PSTN) connection path, said voice communication system comprising:
at least one user computer for generating, in response to user input, messages for controlling the creation of said VoIP connection path and said PSTN connection path and sending said messages to a server computer; and
a server computer for receiving the messages generated by said at least one user computer and, in accordance therewith, controlling the creation of either said VoIP connection path or said PSTN connection path.

22. The system of claim 21 wherein said at least one user computer includes a soft-phone application that includes a graphical user interface for receiving user input.

23. The system of claim 22 wherein said graphical user input includes a phone icon the color of which is dependent on which of the VoIP connection path and the PSTN connection path is created.

24. The system of claim 21 wherein the server computer includes an application program that selectively produces a VoIP port object and a PSTN port object depending upon whether the VoIP connection path or the PSTN connection path is created.

25. The system of claim 24 wherein the VoIP port object includes a first module for encoding telephone voice signals into a form suitable for transmission using a predetermined protocol and a second module suitable for packetizing the encoded telephone voice signals prior to transmission to the user computer.

26. The system of claim 25 wherein said second module also depacketizes encoded telephone voice signals received from the user computer and said first module also decodes the depacketized encoded telephone voice signals.

27. The system of claim 24 wherein said application program includes a first program module for placing call control signals in a form suitable for packetizing and a second program module for packetizing the call control signals.

28. The system of claim 27 wherein the second program module also depacketizes call control signals and the first program module converts the depacketized call controls signals into call control signals.
